(19) United States
(12) Patent Application Publication
(10) Pub. No.: US 2012/0212846 A1
(43) Pub. Date: Aug. 23, 2012

(54) Method of Calibrating Data Readers Relative to Servo Readers

(75) Inventors: Steven Michael Kientz, Westminster, CO (US); Keith Gary Boyer, Broomfield, CO (US); Matthew K. Tucker, Boulder, CO (US)

(73) Assignee: ORACLE INTERNATIONAL CORPORATION, Redwood City, CA (US)

(21) Appl. No.: 13/032,738

(22) Filed: Feb. 23, 2011

(51) Int. Cl. G11B 27/36; G11B 5/02

(52) U.S. Cl. 360/31; 360/55; G9B/27.052; G9B/5.026

(57) ABSTRACT

A method of calibrating a servo reader and a read/write head for a data storage tape machine that reads and writes data to a data storage tape. The data storage tape has a servo pattern that is recorded on the tape in a known location. The servo pattern is used to provide precise position information for the data storage tape. According to the method, data is recorded on the data storage tape and the location of the data storage track is read. The location of the data storage tape is compared to the known location of the servo pattern to establish a reader offset value. The data storage tape machine is updated based upon the reader offset value to adjust the position of the read/write head.

### TECHNICAL FIELD

This disclosure relates to a method of separating and quantifying error in reading and writing data to a data storage tape.

### BACKGROUND

Data storage tape machines include read/write heads that are positioned with reference to servo patterns that are provided on the tape. Prerecorded servo patterns may be recorded on some types of data storage tapes as permanent recordings that are never overwritten. The permanently recorded servo patterns are written to the tape by the tape manufacturer using a specially designed servo write head. The permanent servo patterns may be provided in a herringbone pattern that is written on one side of the tape. The permanent servo pattern may have between 5 and 10 bands that are repeated at precise intervals along the length of the tape.

The servo patterns are read by a narrow reader that detects the servo pattern timing bands based upon the transverse position of the servo bands. Two servo readers are positioned to simultaneously read two servo bands. The data reader and writer elements are positioned between the servo reader pair. As data is written and read, the servo bands are also read to provide precise position information. The data tracks written across the width of the track record the position information and use the servo bands as a reference guide. The amount of error in the read back servo signal is continuously monitored and is reported as the position error signal.

Accuracy of the system for following the servo track becomes more important as the density of the data stored on the tape is increased. If the tracks are not written precisely where intended, difficulties may arise during data recovery when the tape system attempts to read back the stored data. Data track misplacement may be caused by an incorrect servo pattern recording, inaccurate written track width, inaccurate read track width, the read head not being centered relative to the magnetic centerline of the read head, or incorrect location of write elements on the read/write head relative to the servo reader heads. Any of the above factors may result in data tracks being written on the tape in the wrong location.

If data is written in the wrong location, the read elements of the read/write heads may be off of the center of the track when attempting to read back data. It is difficult to determine and quantify the amount of error that is attributable to the read side or the write side of the system. These position based errors may cause problems in data recovery.

Applicants' disclosure as summarized below addresses the problem of removing, or minimizing, the position offset error of the servo position signal so that position of the read/write heads can be more accurate.

### SUMMARY

In one approach, a special servo writer may be used to write a calibration servo pattern using low-frequency tones that are centered at the location of a plurality of data readers. The use of low frequency tones is only one way of practicing the invention. Other signals of known data patterns may also be used in practicing the invention. The low-frequency tone pattern may have a fixed width so that by scanning each pattern with a read/write head, a “bathtub” position curve may be developed that has transition points that correspond to the upper and lower edge of a data track. The term “bathtub” refers to the shape of the data track position signal. From this, the center of the position curve may be determined and the distance that the data reader is offset from its nominal target position may be calculated with respect to the location of the low-frequency tone servo pattern. The offset from the linear fit of the measured offsets of each data reader may yield an average servo reader offset value. The average servo reader offset value may be used to calibrate the servo readers that are used to read the servo pattern on the data tape.

Alternatively, a specialized servo writer may write a servo pattern having a width that is greater than the servo band pitch. Signals from the data readers may be selected and demodulated in the same manner as a servo reader. The location of the data readers relative to the servo reader can be determined and any errors may be compensated for by calibrating the data tape storage machine.

In another approach, a small localized servo pattern may be centered at the center of each read/write head. Again, signals from the data readers may be selected and demodulated like a servo reader and the location of the data readers relative to the servo reader can be determined and the data tape storage machine may be calibrated to account for any errors.

According to one aspect of the method, data is written to a data storage tape that has a plurality of servo bands written on the tape and also includes a data track area. The method comprises writing data tracks to the data track area of the tape. The servo bands are read with at least two servo readers to provide precise positioning information. The data tracks are read with a plurality of data readers that record location of the data tracks across the width of the data tape using servo band position data as a guide. The read/write head steps in the transverse tape direction to read the upper edge position and the lower edge position of each data track. The center of each data track is determined and a track center location is generated for each data track. The error in the read back servo signal is monitored to provide a position error signal.

According to another aspect of the disclosure, a method of calibrating a servo reader and the read/write heads of the data tape storage tape machine is disclosed. The data storage tape has a servo pattern recorded on the tape in a predetermined location. The servo pattern is used to provide precise position information for the data storage tape. The method of calibrating the servo reader and read/write heads begins by recording data on the data storage track of a data storage tape. The location of the data storage track is read and then compared to the known location of the servo pattern to establish a reader offset value. The data storage tape machine is updated to adjust the position of the read/write head based upon the reader offset value.

The above aspects of Applicants' disclosure will be better understood in view of the attached drawings and the following detailed description of the illustrated embodiments.

### BRIEF DESCRIPTION OF THE DRAWINGS

FIG. 1 is a perspective view of a data storage tape system read/write head assembly that is an example of the type of apparatus that may be used in accordance with the disclosed method;

FIG. 2 is a diagrammatic view of an example of a data storage tape that may be used with the disclosed method;

FIGS. 3A-3C are diagrammatic views illustrating the data track offset that is measured by the disclosed method at the top, middle and bottom of the data storage tape; and

FIG. 4 is a diagrammatic view showing the cumulative offset of the center of a plurality of data tracks that is determined by the disclosed method.

### DETAILED DESCRIPTION

Several embodiments of the present disclosure are addressed in this detailed description of the illustrated embodiments. The disclosed embodiments are examples of the invention that may be embodied in various and alternative forms. The figures are not necessarily to scale and some features may be exaggerated or minimized to show details of particular components. The specific structural and functional details disclosed are not to be interpreted as limiting, but merely as a representative basis for teaching one skilled in the art to practice the invention.

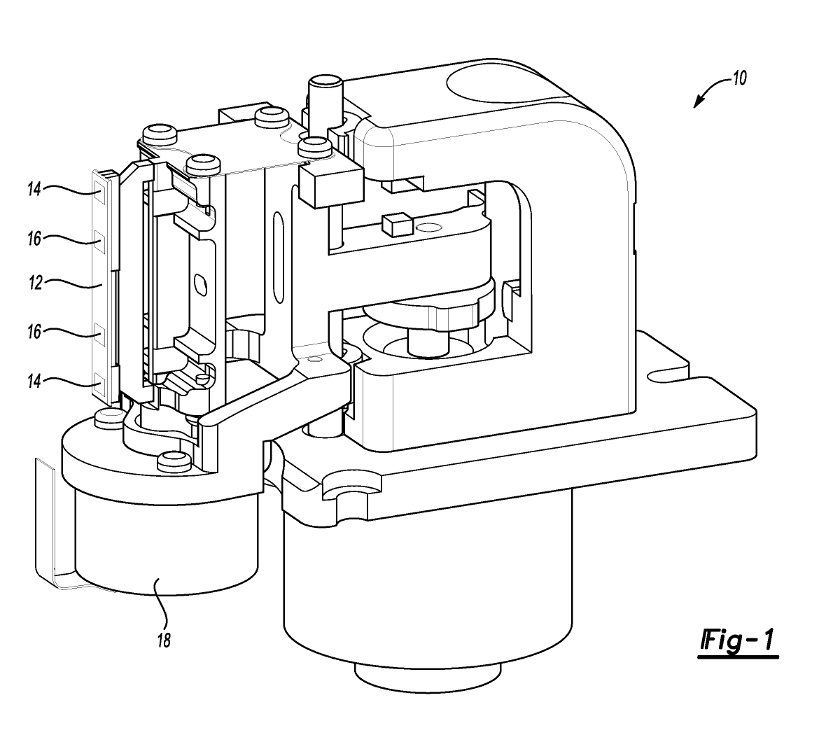

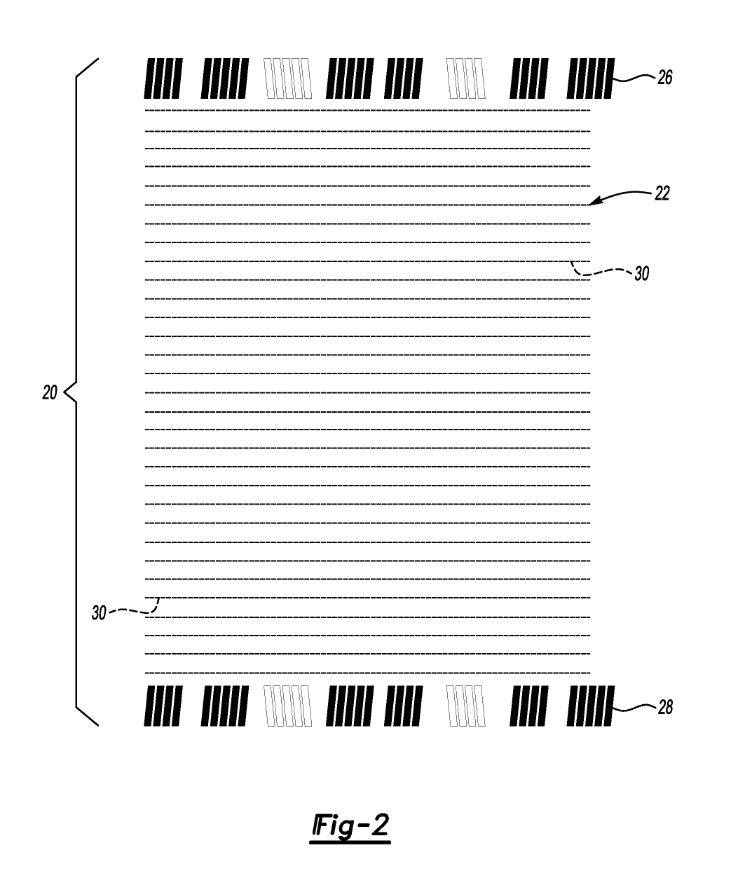

Referring to FIG. 1, a read/write head assembly 10 for a data storage tape drive is shown to include a read/write head 12. The read/write head 12 includes at least one servo reader element 14 and at least one read/write element 16. A voice coil drive 18, or linear motor, is operatively connected to the read/write head 12 to move the read/write head relative to a data storage tape 20 that is illustrated in FIG. 2.

Referring to FIG. 2, the data storage tape 20 is shown to include different regions that perform different functions. A data track area 22 is the portion of the tape that receives the data that is read to the data storage tape 20. After the data is stored on the data storage tape 20, it may be read back in the event that it is necessary to restore the data in the storage tape to an operating system. An upper servo band 26 and a lower servo band 28 are also included on the data storage tape 20. As used herein, references to the upper and lower relative directions refer to a tape 20 that is inserted in a data storage drive in which the tape is moved in a horizontal direction across the read/write head 12. As to data storage tapes 20 that are loaded into a machine in a vertical or other orientation, the term “lower” should be understood as being the side of the tape closest to the voice coil drive 18 and the term “upper” refers to the side of the tape that is furthest from the voice coil drive 18.

A plurality of data tracks 30, or wraps, are recorded on the data storage tape in the data track area 22. As data is written to the data storage tape 20, data is written on the data track in a serpentine pattern of wraps. In many instances, two read/write heads may be provided to read and write data from the data storage tape with each read/write head being assigned to one half of the data track area 22.

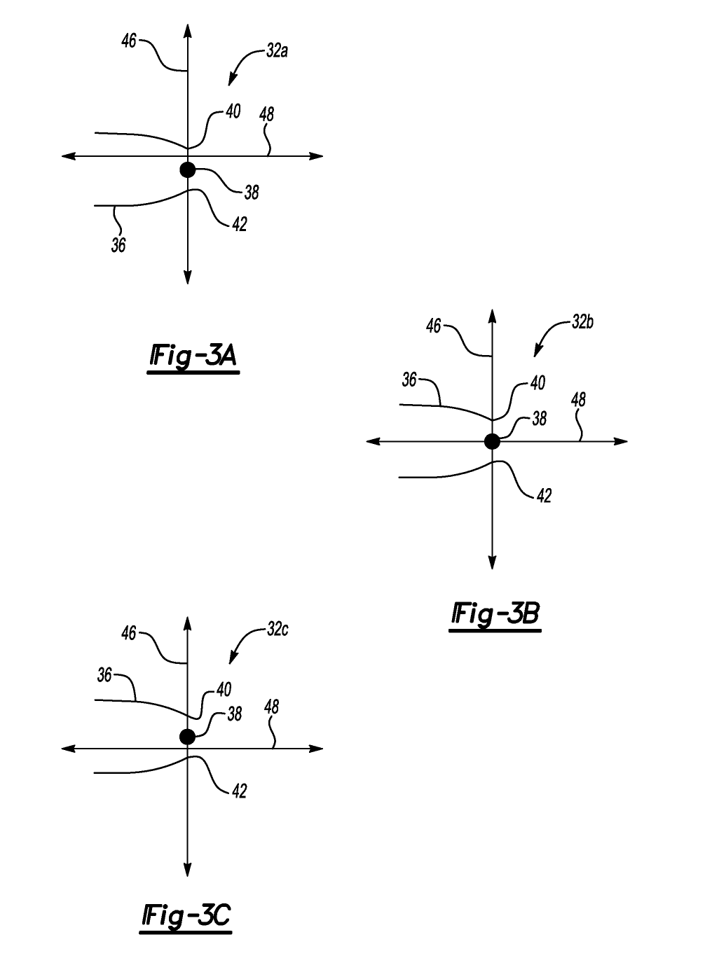

Referring to FIGS. 3A-3C, three data track offset diagrams 32 are provided that illustrate a typical data band curve 36. The data band curve 36 has a center 38 that is determined based upon the location of the upper edge 40 and lower edge 42 of the data band curve 36. In FIG. 3A, the center 38 of the data band curve 36 is offset along the position measurement axis 46 so that it is below the actual position axis 48. The actual position axis 48 shows the anticipated location of the center 38 of the data band for a given data track 30. In FIG. 3A, the center 38 is below the actual position axis 48 indicating that the data track 30 is offset relative to its expected location.

Referring to FIG. 3B, the data band curve 36 has an upper edge 40 and a lower edge 42 that are equidistant from the actual position axis 48. The center 38 of the data band curve 36 for the central data track 30 is not offset from the actual position axis 48.

Referring to FIG. 3C, a data band curve 36 is shown that has a center 38 that is offset along the position measurement axis 46 to the location above the actual position axis 48.

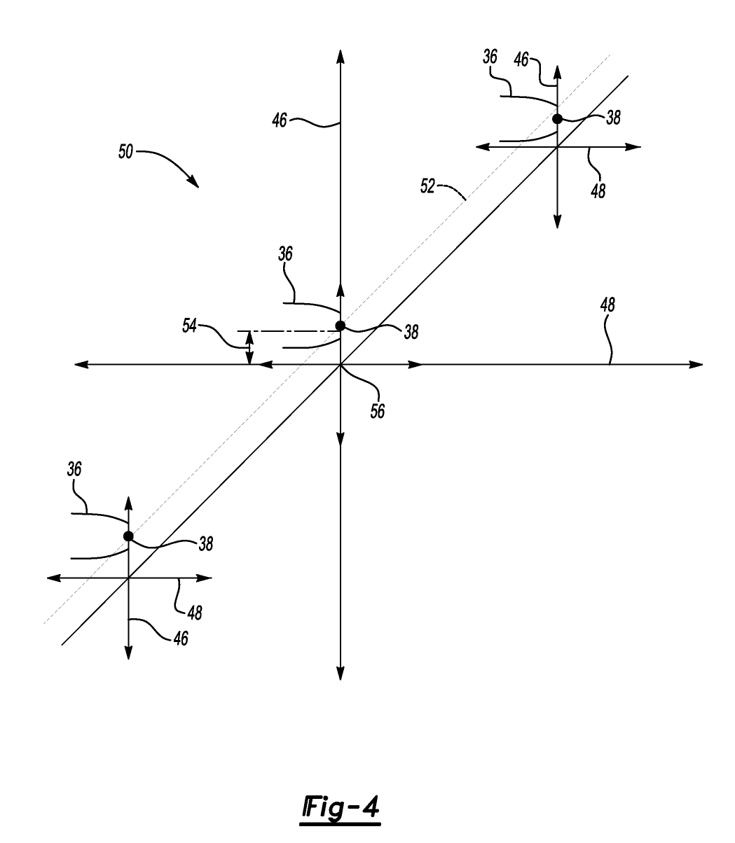

Referring to FIG. 4, a cumulative offset diagram 50 is provided that illustrates the linear fit line 52 of the center offsets of a set of data tracks 30, as shown in FIG. 2. The cumulative offset diagram 50 illustrates the data band curves 36 across the width of the data storage tape shown in FIG. 2. Each of the data band curves 36 are shown with center points 38 that are aligned on the linear fit line 52 of the center offsets. The cumulative offset diagram 50 is aligned with the center of the data tape 30 and includes a position measurement axis 46 and an actual position axis 48. The axes 46 and 48 have an origin corresponding to the calculated data band center location 56.

According to Applicants' method, a technique is provided for separating and quantifying the write side error and the read side error that are caused by data tracks 30 being slightly offset. According to the method, a special servo write head writes the servo band and also writes a plurality of data tracks that are positioned to line up with the read elements of a tape drive head. The servo write head is used to write servo bands and a plurality of data tracks are accurately located relative to write elements of a known width. The special servo write head is prepared using lithographic techniques to provide a servo write head with precision located servo and write elements. The calibration track written by the special servo write head may have a specified frequency or tone or may be specially formatted data. Alternatively, a pseudo random data pattern may be written by the servo write head.

When a tape written with a servo pattern and calibration data track are loaded into a data storage tape drive, the drive may read the prewritten data tracks. The data elements are read at multiple transverse offsets across the width of the data tracks. The read head is stepped up and down to read the upper and lower edge positions of the written data track. Based upon the upper and lower edge positions, the center of the data track may be determined. In this way, an off track read profile is established. A statistical mean and variance of the track centers can be obtained by reading all of the read elements. This approach solves the problem of the magnetic center-line of the read head not being centered relative to the physical center of the read head. By averaging the offsets of the read elements, the offset of the magnetic center-line shift may be accurately measured. The exact center location of the readers for a given drive may be obtained according to this part of the method. All the data tracks may be written by the drive under test as the drive actually writes the tape. Another off track read profile can be obtained that is based upon the data tracks written by the drive under test. The write track center location can also be obtained which compensates for the known error in the reader location.

The center location data for the read and write heads can be stored in the tape drive/memory. The center location data can be used on subsequent writing of customer data to accurately position the write tracks in their ideal locations on the data storage tape. Generally, the full length of a tape is not used for a customer data storage application. Since the full length of the tape is not used, the data calibration tracks written by the special servo write head are not fully over-written and the remaining portions of the calibration track can be referenced to generate new track center location information.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of reading and writing data to a data storage tape that has a plurality of servo bands written on the tape and a data track area, the method comprising:
writing data tracks to the data track area of the tape;
reading the servo bands with at least two servo readers to provide precise position information;
reading the data tracks with a plurality of data readers and recording the location of the data tracks across the width of the data tape using servo band position data as a guide;
stepping the read head in the transverse tape direction and reading the upper edge position and the lower edge position of each data track;
determining the center of each data track and generating a track center location for each data track;
monitoring the amount of error in the read back servo signal; and
reporting a position error signal.

2. The method of claim 1 wherein the step of determining the center of each data track further comprises averaging the lower edge position and the upper edge position to provide a centerline position of the data storage track.

3. The method of claim 1 wherein the servo bands are recorded on the recording side of the tape before the data tracks are written to the tape.

4. The method of claim 1 further comprising writing a low frequency tone pattern that is centered with respect to a plurality of data tracks, and measuring the position of the data track relative to the servo bands.

5. The method of claim 4 further comprising determining the lower edge position and the upper edge position to determine the distance between the data reader is offset from a nominal target position with respect to the servo bands.

6. The method of claim 5 further comprising comparing the data reader offset from a plurality of data readers to determine an average servo reader offset, and calibrating the servo readers based upon the linear fit of the measured offsets.

7. A method of calibrating a servo reader and a read/write head of a data storage tape machine that reads and writes data to a data storage tape that has a servo pattern recorded on the tape in a known location that is used to provide precise position information for the data storage tape, the method comprising:
recording data on a data storage track of a data storage tape;
reading the location of the data storage track;
comparing the location of the data storage track to the known location of the servo pattern to establish a reader offset value; and
updating the data storage tape machine based upon the reader offset value to adjust the position of the read/write head.

8. The method of claim 7 wherein the step of reading the location of the data storage track further comprises locating an upper edge position and a lower edge position of each of the data storage tracks.

9. The method of claim 8 further comprising averaging the lower edge position and the upper edge position to provide a centerline position of the data storage track.

10. The method of claim 7 wherein the step of reading the location of the data storage track further comprises locating the center of the data storage track.

11. The method of claim 7 wherein the step of updating the data storage tape machine further comprises calibrating the location of the centerline of the servo reader.

12. The method of claim 7 further comprising writing a servo pattern having a width that is greater than a pitch value for the servo pattern.

13. The method of claim 12 further comprising demodulating the signal from the read/write head to determine the position of the read/write head relative to the servo reader.

14. The method of claim 13 further comprising calibrating the data storage tape machine to compensate for errors relative to a nominal position of the read/write head.
